(19) United States
(12) Patent Application Publication
(10) Pub. No.: US 2015/0120825 A1
(43) Pub. Date: Apr. 30, 2015

(54) SEQUENTIAL SEGREGATED SYNCHRONIZED TRANSCRIPTION AND TEXTUAL INTERACTION SPATIAL ORIENTATION WITH TALK-OVER

(71) Applicant: AVAYA, INC., Basking Ridge, NJ (US)

(72) Inventors: Harvey Waxman, Holmdel, NJ (US); John H. Yoakum, Cary, NC (US)

(73) Assignee: AVAYA, INC., Basking Ridge, NJ (US)

(21) Appl. No.: 14/063,686

(22) Filed: Oct. 25, 2013

(51) Int. Cl. H04L 29/06

(52) U.S. Cl. CPC H04L 65/403
USPC 709/204

(57) ABSTRACT

Disclosed is a system and method for sequential segregated synchronized transcript for a multi-party conference. Multiple transcriptions, or their textual streams, are utilized to build segregated, time oriented user interfaces. Horizontally overlapping segments may reflect talk-over of two or more conference participants talking at the same time.

### FIELD OF THE INVENTION

The field of the invention relates generally to viewing and display of a multi-party conference textual content layout.

### BACKGROUND OF THE INVENTION

In today's market, real-time, or near real-time, transcription for voice and/or video calls may be useful. In some instances, layout of the textual content could offer benefits to certain individuals. Multi-party conferencing solutions provide both video-centric options as well as audio options. Further, multi-party conferencing may be provided through a media server dominated system as well as through emerging peer-to-peer systems and existing peer-to-peer systems.

### SUMMARY OF THE INVENTION

An embodiment of the invention may therefore comprise a method of providing a textual content layout of a multi-party conference comprising a plurality of endpoints, the method comprising for each participant of a plurality of participants, wherein each participant is associated with at least one of said plurality of endpoints, providing a textual content of each contribution of the participant, at at least one of the endpoints, providing a textual content window for each participant, wherein each textual content window contains textual content for each participant synchronized with the textual content of other identified participants.

An embodiment of the invention may further comprise a system for providing a textual content layout for a multi-party conference, the system comprising a plurality of endpoints enabled to provide one or more contributions to the multi-party conference, provide a textual content for each contribution of the plurality of endpoints and provide a synchronized textual content window for the contributions from two or more of said plurality of endpoints wherein the textual content windows are synchronized with each other.

### BRIEF DESCRIPTION OF THE DRAWINGS

FIG. 1 shows a block diagram of one embodiment of a video-centric system for providing multi-party conferencing solutions.

FIG. 2 shows a sequential merged transcript.

FIG. 3 shows a sequential segregated transcript.

FIG. 4 shows a sequential segregated synchronized transcript.

### DETAILED DESCRIPTION OF THE EMBODIMENTS

Some embodiments may be illustrated below in conjunction with an exemplary multi-party conferencing system. Although well suited for use with, e.g., a system using switch(es), server(s), and/or database(s), communications end-points, etc., the embodiments are not limited to use with any particular type of multi-party conferencing system or configuration of system elements.

WebRTC provides a generalized architecture through which embodiments of the invention may be practiced. It is understood that other peer-to-peer architectures are available, or may become available. Embodiments of the invention are not limited to a particular peer-to-peer solution. A peer-to-peer network offering a decentralized and distributed network architecture in which individual nodes in a network (peers) act as both suppliers and consumers of resources is suitable. Where tasks are shared among multiple interconnected peers which each make a portion of resources directly available to other network participants, without the need for centralized coordination by servers, is suitable. The collection of textual content may be performed by a peer and utilized on its own display. The transcription of verbal contributions may be performed by a peer and provided to the other peers. Synchronization of textual input may be performed based on when a particular input is received, or, as discussed, may be based on a time stamp provided by a contributing peer. A peer receiving textual content, both transcribed verbal content and text inputs, will display the textual content in a window associated with the contributing peer. Identification of the appropriate peer may be done by including identification information with transmitted content.

WebRTC is used throughout this description in regard to one or more embodiments. More information regarding WebRTC may be found in “WebRTC: APIs and RTCWEB Protocols of the HTML5 Real-Time Web,” by Alan B. Johnston and Daniel C. Burnett, 2nd Edition (2013 Digital Codex LLC), which is incorporated in its entirety herein by reference. WebRTC provides built-in capabilities for establishing real-time video, audio, and/or data streams in both point-to-point interactive flows and multi-party interactive flows. The WebRTC standards are currently under joint development by the World Wide Web Consortium (W3C) and the Internet Engineering Task Force (IETF). Information on the current state of WebRTC standards can be found at, e.g., http://www.w3c.org and http://www.ietf.org.

It is also noted, that throughout this description it may be commented that video includes audio or that an audio portion may be included in a mixed audio/video conference. It is understood, that throughout this description, reference to a video conference, stream or portion is intended to include an accompanying audio portion, whether particularly identified or not. Failure to note an audio component at any particular place in this description does not indicate its absence.

For purposes of this application, the term “window” is not limited to any particular type of visual area containing some kind of user interface or interaction. Generally, standard computing windows may have a rectangular shape, but are not necessarily limited to such, that display the output of and may allow input to one or more processes. Windows are primarily associated with graphical displays, where they can be manipulated with a pointer by employing some kind of pointing device, such as a cursor controlled with a mouse. Rather, a window, as used in this description, and specifically when used in regard to the display of textual content, is not so limited. The term “window” is understood to comprise and include any textual display area associated with the textual content associated with a video and/or audio conference. The term “window” is not limited to a particular shape or positioning on a graphical user interface. For instance, a “textual content window” is understood to include any textual display area and may include, but not be limited to, the display of textual content in a unique desktop window, a browser tab, part of a web page, or any other means to create a view of textual content.

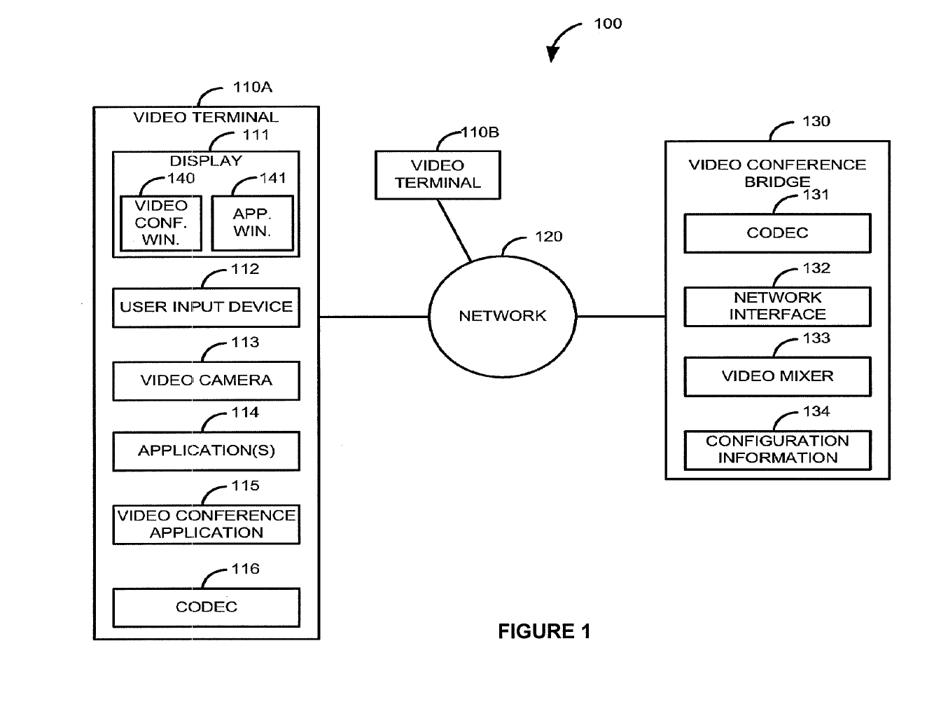

FIG. 1 shows a block diagram of one embodiment of a video-centric system for providing multi-party conferencing solutions. A system 100 comprises video terminals 110A-110B, network 120, and video conference bridge 130. Video terminal 110 can be any type of communication device that can display a video stream, such as a telephone, a cellular telephone, a Personal Computer (PC), a Personal Digital Assistant (PDA), a monitor, a television, a conference room video system, and the like. Video terminal 110 further comprises a display 111, a user input device 112, a video camera 113, application(s) 114, video conference application 115 and codec 116. In FIG. 1, video terminal 110 is shown as a single device; however, video terminal 110A can be distributed between multiple devices. For example, video terminal 110 can be distributed between a telephone and a personal computer. Display 111 can be any type of display such as a Liquid Crystal Display (LCD), a Cathode Ray Tube (CRT), a monitor, a television, and the like. Display 111 is shown further comprising video conference window 140 and application window 141. Video conference window 140 comprises a display of the stream(s) of the active video conference. (“Display” is a broad term that is meant to include audio presented to a participant. It is understood that a stream of an active video conference typically comprises an audio portion and a video portion. An audio portion is not typically displayed in the normal sense of the word. However, the audio portion is “displayed” to a participant in the sense that it is presented along with a video portion. Further, textual content may be displayed at an endpoint associated with an audio portion or with other textual input such as chat or IMs). The stream(s) of the active video conference typically comprises an audio portion and a video portion. Application window 141 is one or more windows of an application 114 (e.g., a window of an email program). Video conference window 140 and application window 141 can be displayed separately or at the same time. User input device 112 can be any type of device that allows a user to provide input to video terminal 110, such as a keyboard, a mouse, a touch screen, a track ball, a touch pad, a switch, a button, and the like. Video camera 113 can be any type of video camera, such as an embedded camera in a PC, a separate video camera, an array of cameras, and the like. Application(s) 114 can be any type of application, such as an email program, an Instant Messaging (IM) program, a word processor, a spread sheet, a telephone application, and the like. Video conference application 115 is an application that processes various types of video communications, such as a codec 116, a video conferencing software/software, and the like. Codec 116 can be any hardware/software that can decode/encode a video stream, and/or an accompanying audio stream/portion. Elements 111-116 are shown as part of video terminal 110A. Likewise, video terminal 110B can have the same elements or a subset of elements 111-116.

Network 120 can be any type of network that can handle video and/or audio traffic, such as the Internet, a Wide Area Net-work (WAN), a Local Area Network (LAN), the Public Switched Telephone Network (PSTN), a cellular network, an Integrated Digital Services Network (ISDN), and the like. Network 120 can be a combination of any of the aforementioned networks. In this exemplary embodiment, network 120 is shown connecting video terminals 110A-110B to video conference bridge 130. However, video terminal 110A and/or 110B can be directly connected to video conference bridge 130. Likewise, additional video and/or audio terminals (not shown) can also be connected to network 120 to make up larger video conferences. Audio only terminals (also not shown) may also be connected to the network for mixed audio/video conferences.

Video conference bridge 130 can be any device/software that can provide video services, such as a video server, a Multipoint Control Unit (MCU), a Private Branch Exchange (PBX), a switch, a network server, and the like. Video conference bridge 130 can bridge/switch/mix video streams of an active video conference. Video conference bridge 130 is shown external to network 120; however, video conference bridge 120 can be part of network 120. Video conference bridge 130 further comprises codec 131, network interface 132, video mixer 133, and configuration information 134. Video conference bridge 130 is shown comprising codec 131, network interface 132, video mixer 133, and configuration information 134 in a single device; how—ever, each element in video conference bridge 130 can be distributed.

Codec 131 can be any hardware/software that can encode a video signal. For example codec 131 can encode one or more compression standards, such as H.264, H.263, VC-1, and the like. Codec 131 can encode video protocols at one or more levels of resolution. Network interface 132 can be any hardware/software that can provide access to network 120 such as a network interface card, a wireless network function (e.g., 802.11g), a cellular interface, a fiber optic network interface, a modem, a T1 interface, an ISDN interface, and the like. Video mixer 133 can be any hardware/software that can mix two or more video streams into a composite video stream, such as a video server. Configuration information 134 can be any information that can be used to determine how a stream of the video conference can be sent. For example, configuration information 134 can comprise information that defines under what conditions a specific video resolution will be sent in a stream of the video conference, when a video portion of the stream of the video conference will or will not be sent, when an audio portion of the stream of the video conference will or will not be sent, and the like. Configuration information 134 is shown in video conference bridge 130. However, configuration information 134 can reside in video terminal 110A.

After a video conference is set up (typically between two or more video terminals 110), video mixer 133 mixes the video streams of the video conference using known mixing techniques. For example, video camera 113 in video terminal 110A records an image of a user (not shown) and sends a video stream to video conference bridge 130, which is then mixed or switched (usually if there are more than two participants in the video conference) by video mixer 133. In addition, the video conference can also include non-video devices, such as a telephone (where a user only listens to the audio portion of the video conference). Network interface 132 sends the stream of the active video conference to the video terminals 110 in the video conference. For example, video terminal 110A receives the stream of the active video conference. Codec 116 decodes the video stream and the video stream is displayed by video conference application 115 in display 111 (in video conference window 140).

In another embodiment, video terminals can be directly interconnected. Peer-to-peer (P2P) is a type of solution that allows such interconnection where all media manipulation functions are performed in the video terminals themselves. WebRTC is such a solution. Web Real-Time Communications (WebRTC) is an ongoing effort to develop industry standards for integrating real-time communications functionality into web clients, such as web browsers, to enable direct interaction with other web clients. This real-time communications functionality is accessible by web developers via standard markup tags, such as those provided by version 5 of the Hypertext Markup Language (HTML5), and client-side scripting Application Programming Interfaces (APIs) such as JavaScript APIs. Essentially, WebRTC enables browser-to-browser applications for voice calling, video chat, and P2P file sharing without plugins. Those skilled in the art will understand other solutions that lend themselves to P2P interconnection.

An embodiment of the invention provides a sequential segregated and synchronized transcription and textual interaction with spatial orientation with talk-over coverage. Systems in video conferencing technology may offer real-time, or near real-time, transcription for voice and/or video calls. The transcription may also include real-time, or near real-time, translation. Generally, one can expect the accuracy of such systems to be up to 80% or 85%, and improving with time.

Multi-party conferences may be video and/or audio, and may include textual steams, or textual input, such as texting and/or instant messaging, or other textual input. Those skilled in the art will understand alternative means for providing textual streams and content to a multi-party conference. Moreover, such textual input may be directed to a subset of the participants, or to all participants. Accordingly, the textual content viewable in a synchronized layout at one participant's terminal may differ from the textual content viewable in a synchronized layout at a different participant's terminal depending on how all participants direct their textual inputs. Moreover, it is understood that “textual content” may refer to the resulting transcribed verbal communications, and translations of transcribed verbal communication, of participants and to the textual input, via texting, instant messaging or other method of providing textual input, of participants.

These systems of transcription may also be applied to multi-party conference calls, whether video or just voice. In such a situation, a difficulty may arise in deciphering the transcription to determine a particular speaker's contributions or interactions and also retain a context of the video call context. During an active discussion on a multi-party video call, talk-over may also occur where two or more parties to the conference talk, or otherwise provide textual content, concurrently, thus making individual transcriptions or textual displays difficult to understand.

Further, in the context of multi-party conferences, the ability to contextualize chat inputs may be realized by embodiments of the invention. Similar to the isolation of transcriptions of different speakers, chat input can be interwoven in the contextualized and individualized transcriptions to provide ease in understanding.

It is understood by those skilled in the art that there are a variety of transcription solutions available in the market and readily accessible via the internet. These may be found, for example, at realtimetranscription.com, www.ubiqus.com/GB/corporate-transcription.htm, research.microsoft.com/en-us/projects/transcriptor, and zipdx.com/showcase/announce_transc.php. Many of these mentioned solutions may provide sequential transcription with individual talkers identified. However, it is understood that they may not provide the ability to isolate an individual speaker and focus on the individual speaker's contributions while remaining in context with the broader conference. It is also understood that solutions may not distinguish speakers in cross-talk, or talk-over, situations. Cross-talk and talk-over may be considered the same thing for purposes of this description and may be used interchangeably. It is also understood that solutions may not integrate real-time transcription with other forms of textual interactions, such as chat.

In an embodiment of the invention, each speaker in a multi-party conference may have an individual media stream. This may be true in WebRTC architectures or other conference systems where the transcription process is provided with an appropriate time stamp on a per-speaker basis. In such a situation, a media server, as shown in FIG. 1, is not required for an embodiment of the invention. In such a situation, where a solution such as WebRTC, or other peer-to-peer solution, is utilized, the solution creates the interface and the endpoints will create the display. Further, it is understood, that a conference room dialing into such a session may be treated as a single media stream. However, those skilled in the art will also understand means available to distinguish different speaks from a common conference room. This may be done, for example, with individualized microphones, which enable separation. Other methods and systems for distinguishing speakers in a same room are understandable from this description. Further, other systems' textual chat streams may be directly associated with other related media streams from the same participant. Contextualization is readily maintained in this manner.

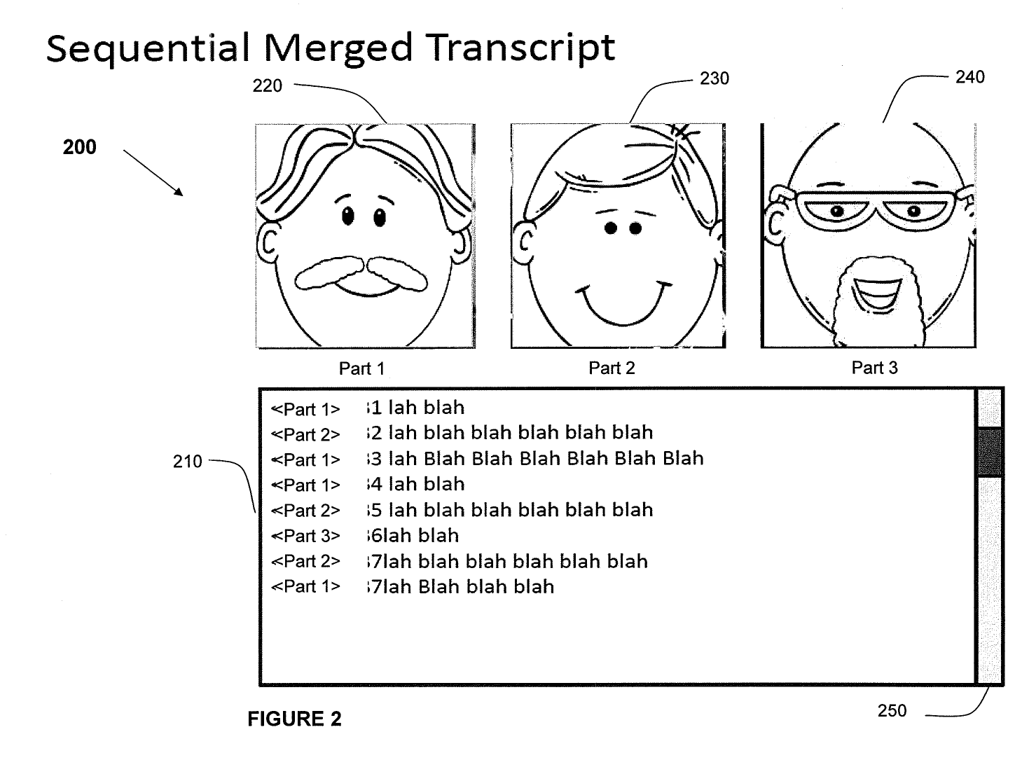

FIG. 2 shows a sequential merged transcript. In a video layout 200 a transcription layout 210 is provided to show the sequence of the conversation. In FIG. 2, a participant 1 220, participant 2, 230 and participant 3 240 are shown. It is understood that there may be more than the three participants shown in the example. Multi-party conferencing systems may all have different limits to the number of participants allowed to participate, or no limits. Those skilled in the art will understand the limits on participation in multi-party conferencing systems. The transcript layout area 210 provides a time contextual transcription of the conversation with distinguishing indicators to distinguish which participant 220, 230, 240 did the relevant speaking. Not shown in FIG. 2 is a non-relative time indicator. A non-relative time indicator may indicate the time each statement in the transcription layout area 210 was made. It is understood that any non-relative time indication may be the time of day, the time/duration of the conference, or other non-relative time indicator to give a viewer further contextual information. Moreover, while this description indicates that the time indicator is, or may be, non-relative, the time indication may provide relative information. The time indicator, it is understood, if an absolute indicator such as the time of day (in whatever degree of fineness) will provide an indication of any breaks or delays or time between comments.

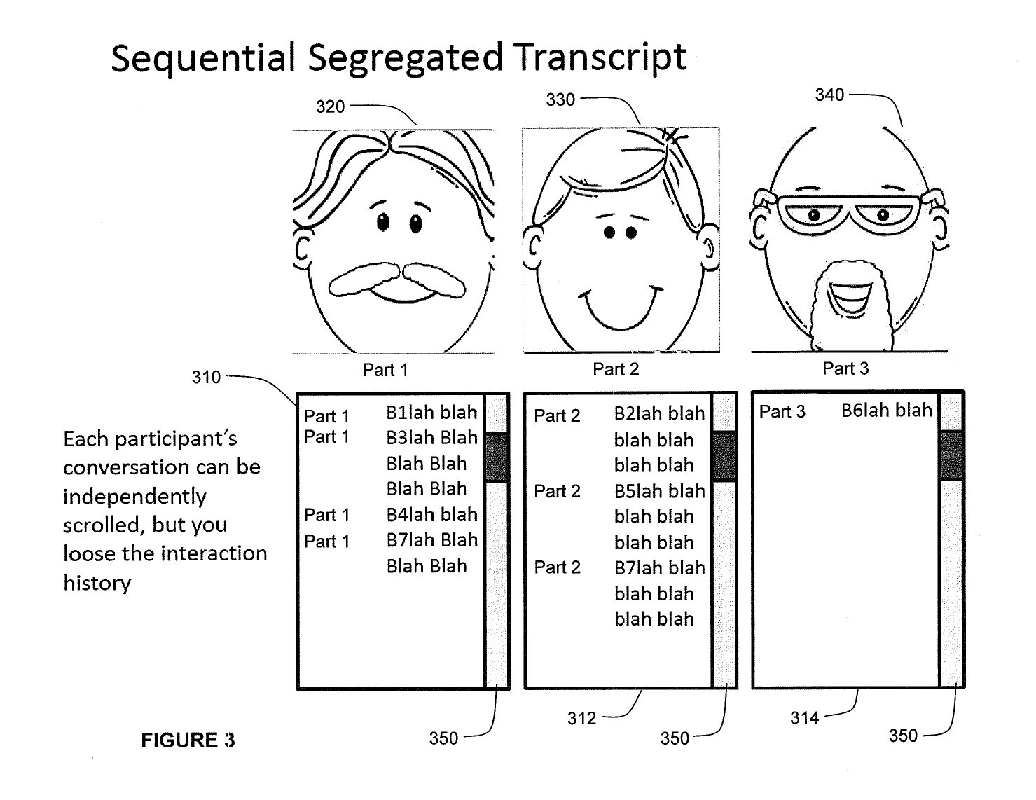

FIG. 3 shows a sequential segregated transcript. In a video layout 310, each participant's conversation can be independently scrolled. The transcription areas 310, 312, 314 is captured under the video window for each active meeting participant 320, 330, 340. The scrolling may be accomplished with a first scroll bar 350 for participant 1's 320 contributions, a second scroll bar 350 for participant 2's 330 contributions and a third scroll bar 350 for participant 3's 340 contributions. Individually scrolling one contribution, for example participant 1's transcript 310, participant 2's transcript 312 or participant 3's transcript 314, may result in a loss of sequential context.

Not shown in FIG. 3 is a non-relative time indicator. A non-relative time indicator may indicate the time each statement in the transcription layout areas 310, 312, 314 was made. It is understood that any non-relative time indication may be the time of day, the time/duration of the conference, or other non-relative time indicator to give a viewer further contextual information. Moreover, while this description indicates that the time indicator is, or may be, non-relative, the time indication may provide relative information. The time indicator, it is understood, if an absolute indicator such as the time of day (in whatever degree of fineness) will provide an indication of any breaks or delays or time between comments.

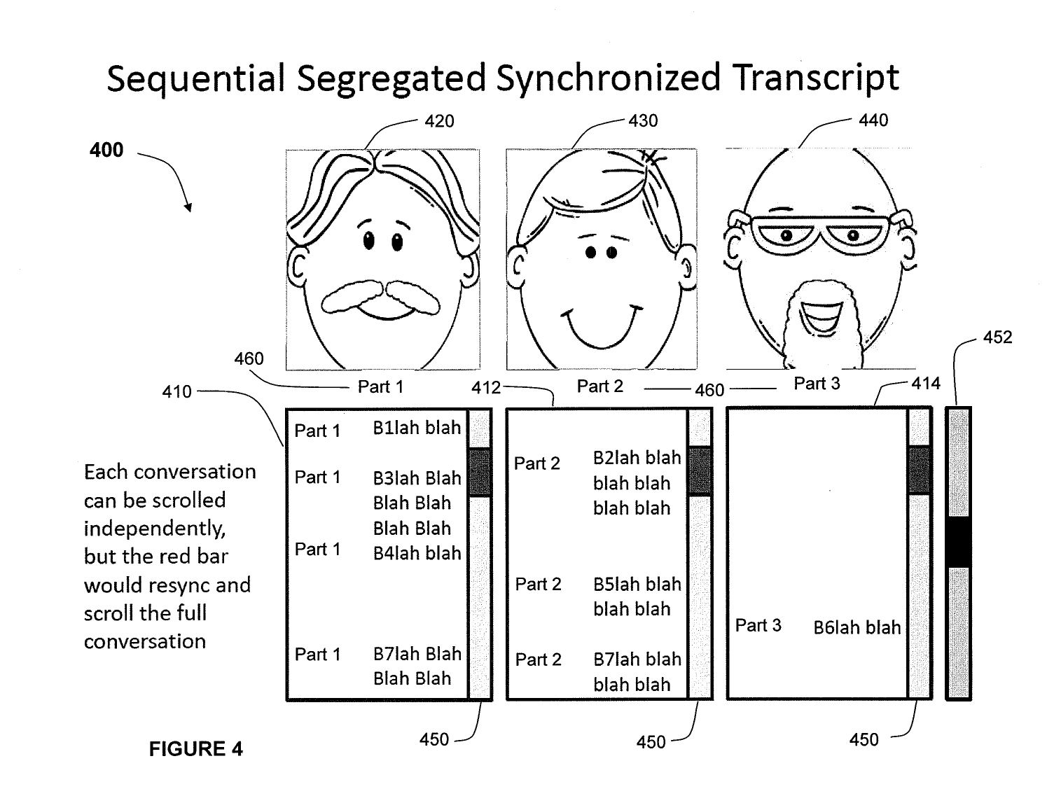

FIG. 4 shows a sequential segregated synchronized transcript. Embodiments of methods and systems consistent with this description may employ multiple transcriptions, or their textual streams, to build a segregated, time oriented user interface. The transcription areas 410, 412, 414 are captured under the identifier for each active meeting participant 420, 430, 440. The identifier for each participant may be a video, a snapshot, or other identification. It may be as simple as a name. Selection of the identifier may be used to provide additional information about that participant. The sequential placement of text aligns with a timestamp of the start of the conversation fragment. The timestamp may be indicated visually in the video layout 400, but is not shown in FIG. 4. Horizontal overlapping of the segments 410, 412, 414 reflect talk-over portions of the overall conversation. The textual content of the layout portion for each participant may be either transcription of a verbal communication by a participant, text input such as text chat or instant messages (IMs), or both. As discussed, it is understood that the multi-party conference may be a video conference or an audio conference with an associated terminal layout. In such a scenario, participant identification may be a predetermined snapshot or other identification as discussed previously. In a video or audio conference, it is understood that transcriptions and other textual input will be interleaved together to provide a synchronous context as shown in FIG. 4. Those skilled in the art will understand peer-to-peer communications and will appreciate the applicability of such solutions, such as WebRTC and others, to embodiments of this invention.

Interlaced with the real-time transcription or other textual streams as mentioned in this description may be inclusion in a like time oriented fashion both public and private chat messages. In the absence of real-time transcription, the presences of chat correspondence in the transcription windows 410, 412, 414, the other textual streams may be exclusively used. This may be used with the mentioned time stamps keyed not only to the spatial display, but also to the playback of a recorded session.

The individual scroll bars 450 allow a single speaker (or conference room) to be scrolled backward or forward to isolate that party's contributions. Clicking the main scroll bar 452 would realign the transcription windows 410, 412, 414 to immediately provide context around a segment of interest. A segment of interest can be determined in a number of manners. For example, highlighting a certain portion of conversation may determine a segment of interest. Also, for example, a last moved individual scroll bar 450 may be used to indicate a segment of interest. Those skilled in the art will understand a variety of ways to determine a segment of interest. Further, the main scroll bar 452 also allows the entire conversation to be scrolled back or forward in an alighted fashion, with context retained.

The ability to maintain a clear context of the transcription of a meeting where parties are talking over each other is provided in the system of FIG. 4. The ability of users to focus their attention of a specific individual is also provided. A view of interaction dynamics and negotiation tactics—is also provided.

Also, the video window 400 may provide a user name 460 for each participant as well as the real-time transcription. The user name 400 can be utilized to provide a direct expansion enablement, or via a link, to provide more detailed credential information, or other information, about each participant to allow others to better understand the background of the participant who is actively participating in the conference call. This information may include company names, job titles, reporting relationships to other meeting participants or any other information that is deemed valuable as non-limiting examples. It is understood that the link may be provided in the participant name 460 or in the participant image 410, 412, 414 or by any other means that is deemed useful or convenient to a system admin or other person.

It is understood, that while the transcription is provided in real-time, allowing a participant to look back during a meeting or for a participant joining late to quickly get up to speed, after the session has ended, the entire session with the sequential segregated and synchronized transcripts may be saved for later playback and searching.

As noted above, the methods and systems of the currently described sequential segregated synchronized transcript may be used in connection to WebRTC. It is understood that the described sequential segregated synchronized transcript may be used in other communications systems. It is understood that WebRTC (Web Real-Time Communication) is an architectural approach which enables browser-to-browser interactions for voice calling, video chat, and P2P file sharing without plugins. WebRTC is not limited to browser to browser enablement and may be extended to non-browser environments.

It is understood that embodiments of the invention may merge different forms of media and different forms of communication may be merged into a single textual content display. Also, each participant's terminal layout may be personalized. For instance, a participant may desire to not have streamed video during a video conference to save bandwidth. That participant may opt to only view snapshots for some participants while viewing video of other participants, for example the most active participants.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of providing a textual content layout of a multi-party conference comprising a plurality of endpoints, said method comprising:
for each participant of a plurality of participants, wherein each participant is associated with at least one of said plurality of endpoints, providing a textual content of each contribution of said participant;
at at least one of said endpoints, providing a textual content window for each participant, wherein each textual content window contains textual content for each participant synchronized with the textual content of other identified participants.

2. The method of claim 1, said method further comprising time stamping said textual content contributions.

3. The method of claim 1, wherein said process of providing a textual content for each participant comprises transcribing verbal content into textual content.

4. The method of claim 1, wherein said textual content comprises textual input from a participant.

5. The method of claim 1, wherein said textual content comprises a transcript of verbal communications from a participant and textual input from a participant.

6. The method of claim 1, wherein each textual content window at an endpoint is individually scrollable.

7. The method of claim 1, wherein all of said textual content windows at an endpoint are unified-ably scrollable.

8. The method of claim 1, wherein each textual content window is individually scrollable and all of said windows are unified-ably scrollable.

9. The method of claim 1, wherein a segment of one of said textual content windows is identifiable.

10. The method of claim 9, further comprising synchronizing all of said textual content windows to a segment of one window by scrolling the windows using a main scrolling mechanism.

11. The method of claim 1, wherein contributions from said plurality of participants is sequentially placed in said associated textual content windows.

12. The method of claim 11, wherein at least a portion of one of said contributions from a particular participant is aligned visually as an indication of overlap in time with another contribution from at least one other participant.

13. A system for providing a textual content layout for a multi-party conference, said system comprising;
a plurality of endpoints enabled to provide one or more contributions to said multi-party conference, provide a textual content for each contribution of said plurality of endpoints and provide a synchronized textual content window for said contributions from two or more of said plurality of endpoints wherein said textual content windows are synchronized with each other.

14. The system of claim 13, wherein at least a portion of said contributions are verbal contributions and each of said plurality of endpoints are further enabled to transcribe said verbal contributions.

15. The system of claim 13, wherein at least a portion of said contributions are verbal contributions and each of said plurality of endpoints are further enabled to transcribe said verbal contributions, and at least a portion of said contributions are textual input contributions.

16. The system of claim 13, wherein at least a portion of said contributions are textual input contributions.

17. The system of claim 13, wherein each of said textual content windows is individually scrollable.

18. The system of claim 13 wherein all of said textual content windows are unified-ably scrollable.

19. The system of claim 13, wherein each of said textual content windows is individually scrollable and all of said textual content windows are unified-ably scrollable.

20. The system of claim 13, wherein a segment of one of said textual content windows is identifiable.

21. The system of claim 13, wherein contributions from each of said participants is sequentially placed in said associated textual content window.

22. The system of claim 13, wherein at least a portion of one of said contributions from a particular participant is aligned visually as an indication of overlap in time with another contribution from at least one other participant.
